(19) United States
(12) Patent Application Publication
(10) Pub. No.: US 2011/0270862 A1
(43) Pub. Date: Nov. 3, 2011

(54) INFORMATION PROCESSING APPARATUS AND INFORMATION PROCESSING METHOD

(75) Inventor: Keisuke Tamiya, Kawasaki-shi (JP)

(73) Assignee: CANON KABUSHIKI KAISHA, Tokyo (JP)

(21) Appl. No.: 13/143,707

(22) PCT Filed: Mar. 31, 2010
(86) PCT No.: PCT/JP2010/056277

§ 371 Date: Jul. 7, 2011

(30) Foreign Application Priority Data
Apr. 13, 2009 (JP) 2009-097389

(51) Int. Cl. G06F 17/30

(52) U.S. Cl. 707/759; 707/E17.014

(57) ABSTRACT

This invention is directed at providing a technique for implementing higher-speed search processing for a binary structured document. A search query conversion means converts a search query for a structured document by converting each node building the search query into a corresponding index by using a vocabulary list. A document analysis means specifies an index corresponding to each node building the structured document by using the vocabulary list. A search query evaluation means searches for part of the structured document that corresponds to the converted search query, by using each index described in the converted search query and the index corresponding to each node that is specified by the document analysis means.

### TECHNICAL FIELD

The present invention relates to a search technique for a structured document described in a binary format.

### BACKGROUND ART

An XML language, specifications of which are formulated by the W3C standards body, is a language which describes a structured document. The XML language can describe a structured document using components (nodes) such as elements, attributes, and namespaces.

Although a document described in the XML language has a text format, there is a so-called binary XML technique which expresses the same document in a binary format. Typical formats are the Fast Infoset (ITU-T X.891) format standardized by the ITU-T (ITU-T Rec. X.891|ISO/IEC 24824-1 (Fast Infoset)), and the Efficient XML Interchange format whose specifications are under development by the W3C. According to these binary XML techniques, a text document described in the XML language can be expressed in a smaller size using a vocabulary table and node data information.

On the other hand, an XML Path Language (XPath) whose specifications are formulated by the W3C is proposed as a technique of designating, searching for, and extracting a specific part of an XML document (XML Path Language (XPath) Version 1.0 W3C Recommendation 16 Nov. 1999). According to the XPath specifications, an XML document is regarded as a tree structure made up of nodes such as elements, attributes, and texts. A search query is described as a character string called a location step.

The location step is formed from an axis and node test which designate a node, and a predicate which designates a narrow-down condition using a node value or the like. The predicate can designate a character string comparison condition such as “character string data of a text node matches a specific character string.” A technique of quickly comparing character strings in the predicate description has already been proposed (Japanese Patent Laid-Open No. 2007-249773).

A program using part of a binary XML structured document can extract the part by designating a search query described in XPath in a program such as an XML parser which analyzes an XML document, similar to a text XML structured document. In the search query described in XPath, the names of nodes such as elements and attributes are described in a text format. The program which analyzes an XML document checks if a condition for the binary XML format as well as the text XML format is met by comparing the name of a node obtained as a result of analysis with that of a node in the search query.

Processing of searching for a binary XML structured document using a search query described in XPath requires many character string comparison processes, increasing the calculation cost. In general, one purpose of the program using the binary XML format is to quickly perform analysis processing.

### SUMMARY OF INVENTION

The present invention has been made to solve the above problems, and provides a technique for implementing higher-speed search processing for a binary structured document.

According to the first aspect of the present invention, an information processing apparatus characterized by comprising:

means for holding a table in which each node usable in a structured document and an index unique to the node are registered;

means for acquiring a search target structured document described in a binary format;

acquisition means for acquiring a search query for the search target structured document;

conversion means for converting the search query by converting each node building the search query into a corresponding index by using the table;

specifying means for specifying an index corresponding to each node building the search target structured document by using the table;

search means for searching for part of the search target structured document that corresponds to the search query converted by said conversion means, by using each index described in the search query converted by said conversion means and the index corresponding to each node in the search target structured document that is specified by said specifying means; and

means for outputting a result of the search by said search means.

According to the second aspect of the present invention, an information processing method characterized by comprising:

a step of acquiring a search target structured document described in a binary format;

an acquisition step of acquiring a search query for the search target structured document;

a conversion step of converting the search query by converting each node building the search query into a corresponding index by using a table in which each node usable in a structured document and an index unique to the node are registered;

a specifying step of specifying an index corresponding to each node building the search target structured document by using the table;

a search step of searching for part of the search target structured document that corresponds to the search query converted in the conversion step, by using each index described in the search query converted in the conversion step and the index corresponding to each node in the search target structured document that is specified in the specifying step; and

a step of outputting a result of the search in the search step.

The arrangement of the present invention can implement higher-speed search processing for a binary structured document.

Further features of the present invention will become apparent from the following description of exemplary embodiments with reference to the attached drawings.

### BRIEF DESCRIPTION OF DRAWINGS

FIG. 1 is a block diagram exemplifying the hardware configuration of a document search apparatus serving as an information processing apparatus according to the first embodiment of the present invention;

FIG. 2 is a view exemplifying the structure of a structured document which describes a binary XML structured document 142 in a text XML format;

FIG. 3 is a table exemplifying the structure of a vocabulary list 141;

FIG. 4 is a view exemplifying the structure of the structured document 142 obtained by converting the text XML structured document shown in FIG. 2 into the Fast infoset format serving as an example of the binary XML format using the vocabulary list 141;

FIG. 5 is a view exemplifying the structure of the structured document 142 obtained by converting the text XML structured document shown in FIG. 2 into the Fast Infoset format serving as an example of the binary XML format using the vocabulary list 141;

FIGS. 6A to 6D are views showing search queries described in the W3C XPath language, and results of converting the search queries using indices;

FIG. 7 is a flowchart of search processing for the structured document 142 by a document search apparatus 100;

FIGS. 8A and 8B are flowcharts each showing details of processing in step S707;

FIG. 9 is a block diagram exemplifying the hardware configuration of a document search apparatus 900 serving as an information processing apparatus according to the second embodiment of the present invention; and

FIG. 10 is a flowchart of search processing for the structured document 142 by the document search apparatus 900.

### DESCRIPTION OF EMBODIMENTS

Embodiments of the present invention will now be described with reference to the accompanying drawings. It should be noted that the following embodiments are merely examples of specifically practicing the present invention, and are concrete examples of the arrangement defined by the scope of the appended claims.

### First Embodiment

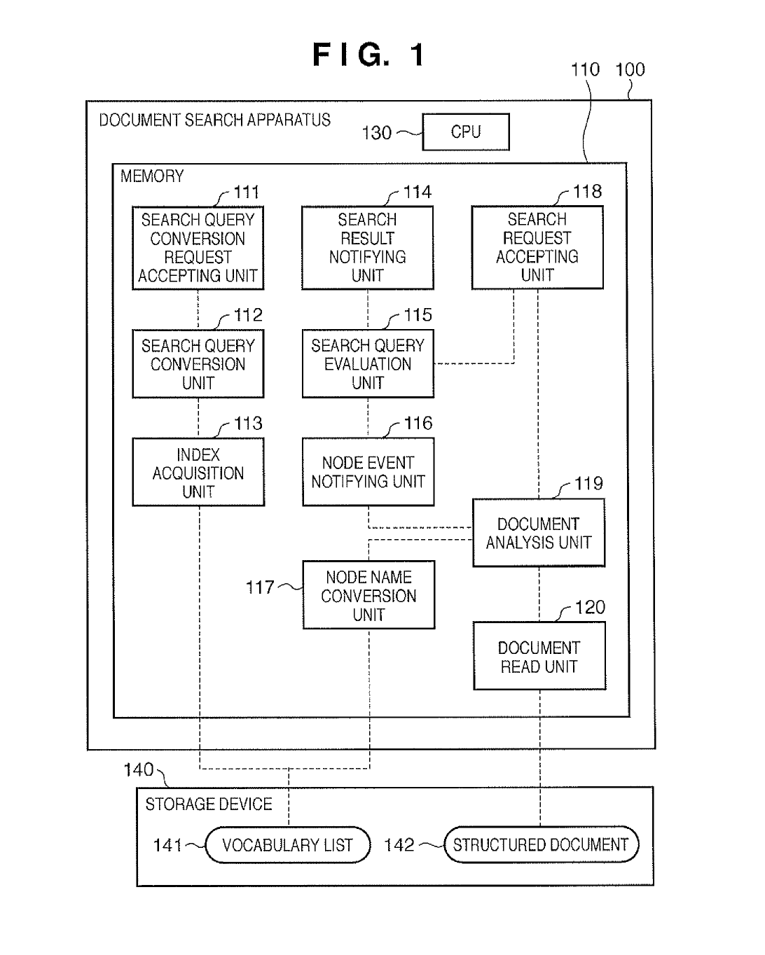

FIG. 1 is a block diagram exemplifying the hardware configuration of a document search apparatus serving as an information processing apparatus according to the first embodiment. FIG. 1 shows the main arrangement in the following description, and the arrangement of an apparatus capable of implementing a technique to be described in the embodiment is not limited to that shown in FIG. 1.

As shown in FIG. 1, a document search apparatus 100 includes a CPU 130 and memory 110. The document search apparatus 100 is connected to a storage device 140 via a cable. The document search apparatus 100 can read out and write data from and in the storage device 140 via the cable.

The storage device 140 is a large-capacity information storage device typified by a hard disk drive. The storage device 140 stores a binary structured document 142 to be searched (search target structured document), and a vocabulary list 141 which holds the name and index of each node appearing in the structured document 142 (search target structured document).

More specifically, the structured document 142 is a structured document in the binary XML format defined in the ISO Fast Infoset and W3C Efficient XML Interchange specifications. Nodes are document units such as elements and attributes which form the structured document 142. A node name registrable in the vocabulary list 141 is the name of a node used in the structured document 142. In addition, the name and index of a node generally usable in a structured document may be registered.

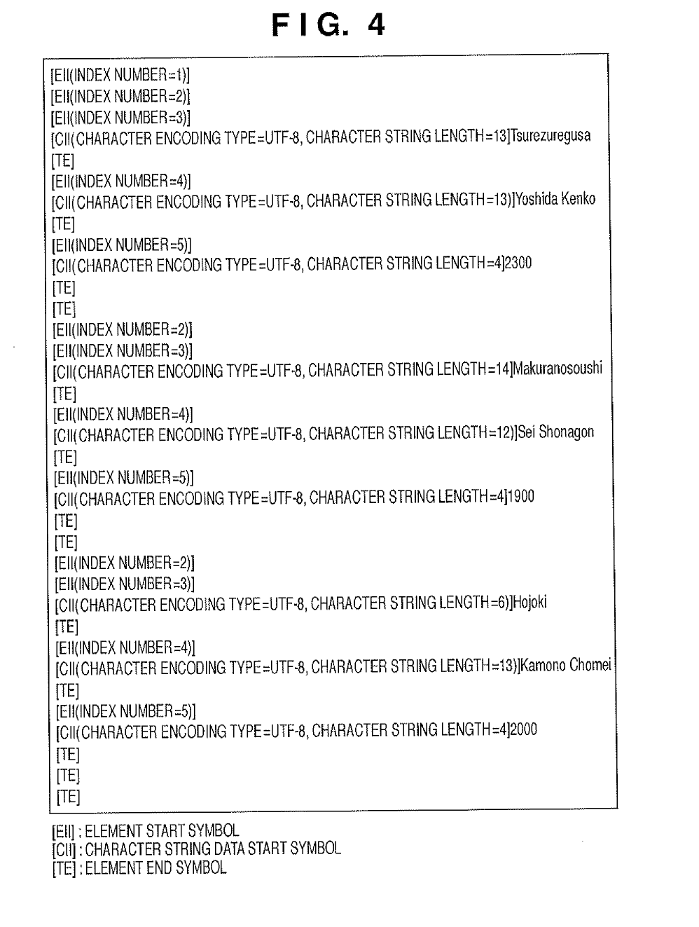

FIG. 3 is a table exemplifying the structure of the vocabulary list 141. The name of each node appearing in the structured document 142 is registered in a column 302. An index unique to each node (unique in the structured document 142) is registered in a column 301. More specifically, a set (entry) of the name of a node and an index unique to the node is registered in the vocabulary list 141 for each node.

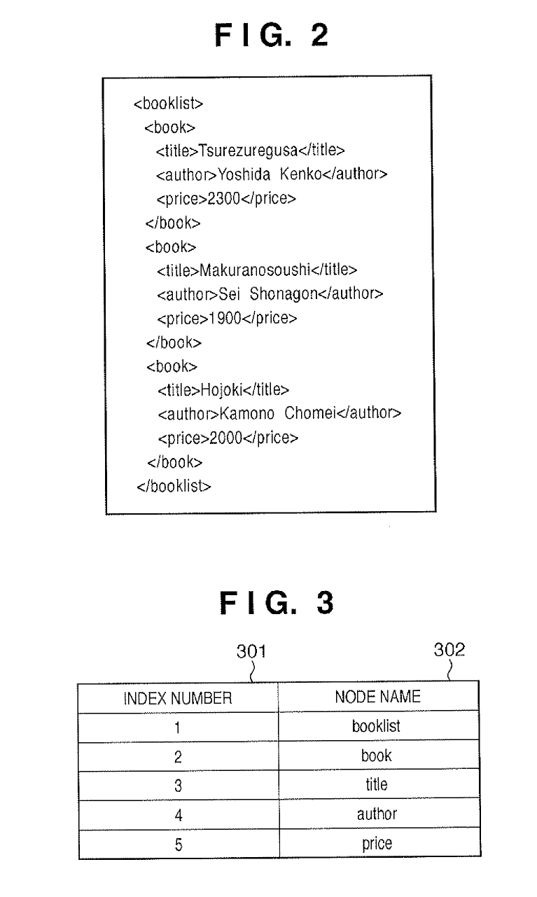

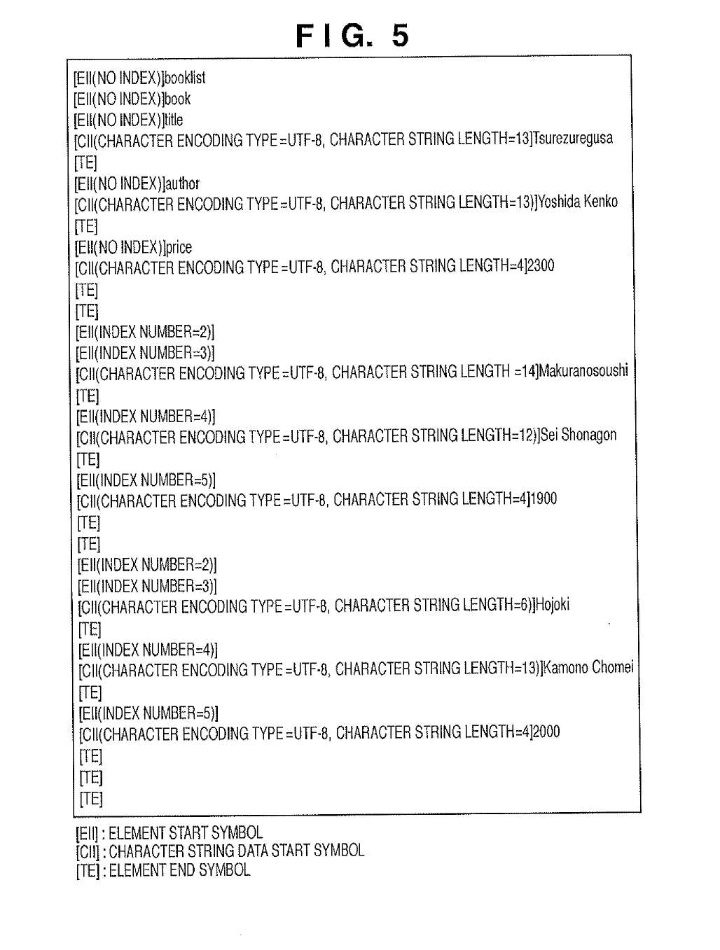

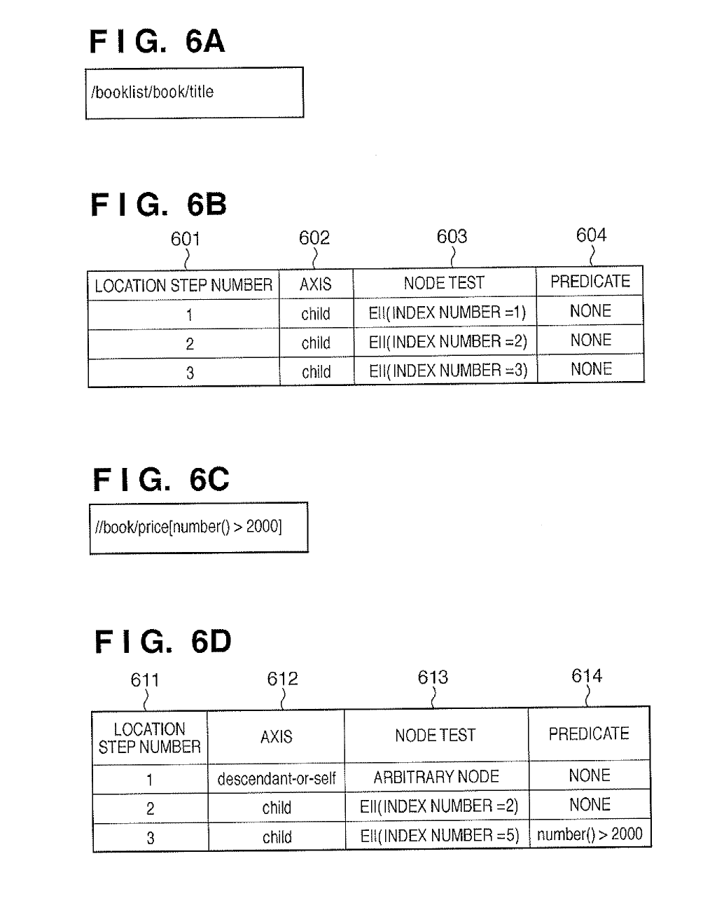

FIG. 2 is a view exemplifying the structure of a structured document which describes the binary XML structured document 142 in a text XML format. FIGS. 4 and 5 are views exemplifying the structure of the structured document 142 obtained by converting the text XML structured document shown in FIG. 2 into the Fast Infoset format serving as an example of the binary XML format using the vocabulary list 141.

According to the Fast infoset format, a structured document is represented by binary symbols indicating the start and end of each node, and a binary string indicating the value of each node. In FIGS. 4 and 5, these binary representations are described as
[node start symbol (parameter)] node value [node end symbol]

In the Fast Infoset, the name of a node can be replaced with an index using the vocabulary list 141. Instead of the index, the node name can also be directly described. FIG. 4 exemplifies the structure of a structured document in which node names are completely replaced with indices. FIG. 5 exemplifies the structure of a structured document in which some node names remain unreplaced.

The structured document 142 and vocabulary list 141 stored in the storage device 140 are loaded into the memory 110 under the control of the CPU 130, as needed, and processed by the CPU 130.

The memory 110 is a readable/writable memory typified by the RAM, and stores units to be described below in the form of computer programs. The units, which are stored in the memory 110 in the following description, may be stored in the storage device 140. Even in this case, these units are loaded into the memory 110 in operation under the control of the CPU 130.

A search query conversion request accepting unit 111 acquires a search query for the structured document 142 via an application program or the like. As a consequence, the search query conversion request accepting unit 111 acquires a request (conversion request) to convert the search query.

An index acquisition unit 113 acquires an index registered in the vocabulary list 141 and supplies it to a search query conversion unit 112. When the search query conversion request accepting unit 111 acquires a search query, the search query conversion unit 112 converts it using the index supplied from the index acquisition unit 113.

A search request accepting unit 118 acquires a search query for the structured document 142 via an application program or the like, thereby acquiring a search request. The search query is one converted by the search query conversion unit 112.

A document read unit 120 reads out the structured document 142. A document analysis unit 119 analyzes the structured document 142 read out by the document read unit 120, and specifies each node described in the structured document 142.

When the document analysis unit 119 detects a node whose name has not been replaced with an index in the structured document 142 as a result of analyzing the structured document 142, a node name conversion unit 117 converts the name into a corresponding index by referring to the vocabulary list 141.

A node event notifying unit 116 notifies a search query evaluation unit 115 of the result of analysis by the document analysis unit 119 as an event. The search query evaluation unit 115 evaluates the search query acquired by the search request accepting unit 118, based on the event received from the node event notifying unit 116. A search result notifying unit 114 outputs (notifies) the result of evaluation by the search query evaluation unit 115.

In addition to these units, information to be described is registered as known information in the memory 110. Also, the memory 110 has a work memory used when the CPU 130 executes various processes. That is, the memory 110 can properly provide a variety of areas.

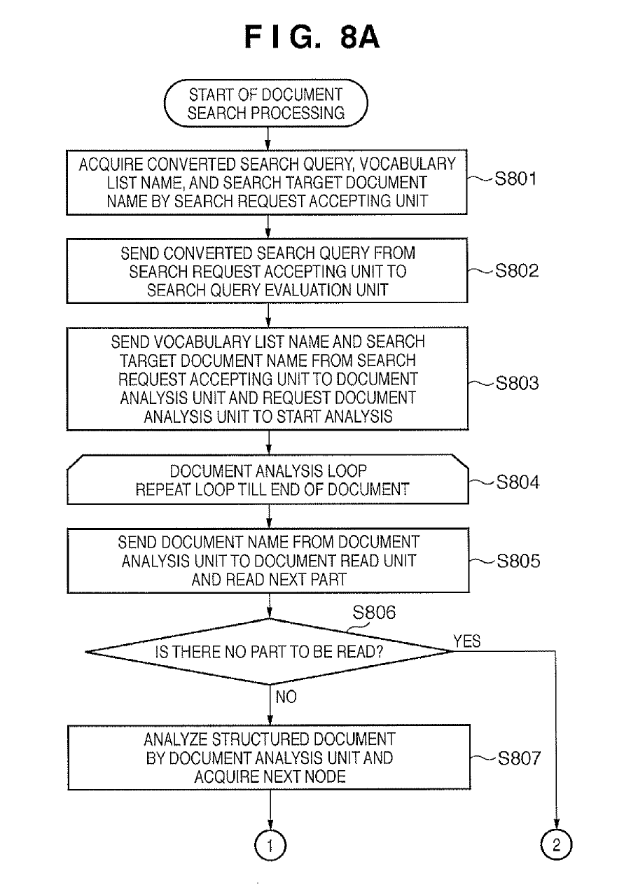

Search processing for the structured document 142 by the document search apparatus 100 will be explained with reference to FIG. 7 which is a flowchart of this processing. For the descriptive convenience, the foregoing units stored in the memory 110 serve as main processors. However, these units are stored in the memory 110 in the form of computer programs, as described above, and the CPU 130 executes these computer programs. In practice, therefore, the CPU 130 is a main processor.

In step S701, the search query conversion request accepting unit 111 acquires a search request by acquiring a search query and the name of a vocabulary list (the file name of the vocabulary list 141 in the embodiment) from an application program or the like. The acquisition form of the search query and the file name of the vocabulary list 141 is not particularly limited. In step S702, the search query conversion request accepting unit 111 sends the acquired file name of the vocabulary list 141 and the acquired search query to the subsequent search query conversion unit 112.

In step S703, the search query conversion unit 112 extracts the name of each node described in the search query received from the search query conversion request accepting unit 111 in step S702. The search query conversion unit 112 sends the extracted node name to the subsequent index acquisition unit 113 together with the file name of the vocabulary list 141 that has also been received from the search query conversion request accepting unit 111 in step S702.

In step S704, the index acquisition unit 113 specifies the vocabulary list 141 in the storage device 140 using the name of the vocabulary list 141 that has been received from the search query conversion unit 112. By referring to the specified vocabulary list 141, the index acquisition unit 113 acquires, from the vocabulary list 141, an index corresponding to each node name received from the search query conversion unit 112. The index acquisition unit 113 sends back the acquired “index corresponding to each node name” to the search query conversion unit 112.

In step S705, the search query conversion unit 112 converts the search query received from the search query conversion request accepting unit 111 by using each index received from the index acquisition unit 113. The conversion of the search query using the index will be explained.

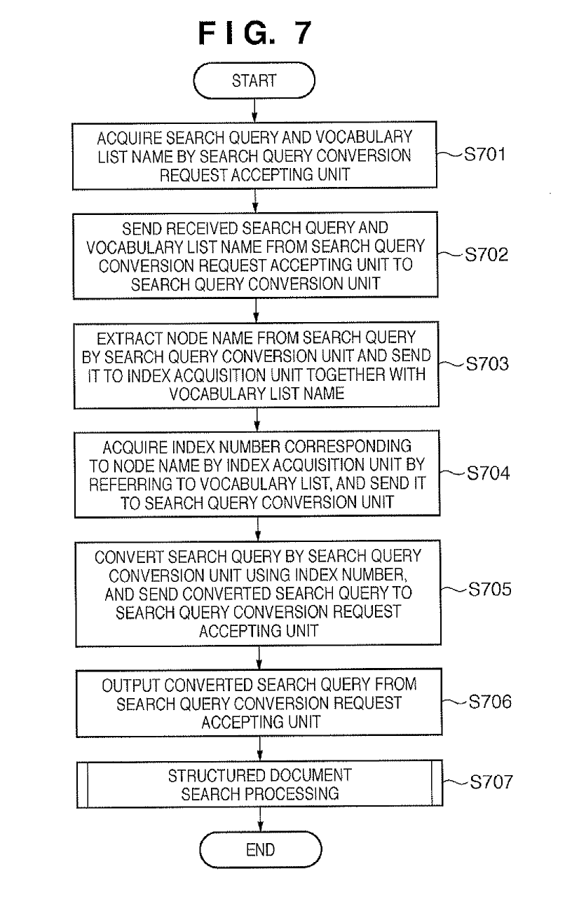

FIGS. 6A to 6D are views showing search queries described in the W3C XPath language, and results of converting the search queries using indices. FIG. 6A shows a search query “/booklist/book/title”.

When the search query conversion request accepting unit 111 acquires this search query and sends it to the subsequent search query conversion unit 112, the search query conversion unit 112 first segments the search query described in the W3C XPath language into search units called location steps. In FIG. 6A, the search query is segmented into three location steps “booklist”, “book”, and “title”. The location step is formed from an axis indicating the search direction of a node in a structured document, a node test designating the type of node, and a predicate serving as a selection condition for narrowing down.

The search query conversion unit 112 operates as follows when it refers to the vocabulary list 141 exemplified in FIG. 3. More specifically, the search query conversion unit 112 acquires, from the vocabulary list 141 for the respective location steps, indices (Eli) corresponding to character strings (booklist, book, title) which are node test values. Then, the search query conversion unit 112 generates information in the form of a table exemplified in FIG. 6B as a converted search query using the acquired indices for the respective location steps.

In FIG. 6B, a number (location step number) unique to each location step is registered in a column 601. The location step number indicates the search order. The axis of each location step is registered in a column 602. The node test value of each location step is registered in a column 603. The predicate of each location step is registered in a column 604.

FIG. 6C shows a search query “//book/price[number( )>2000]”. When the search query conversion request accepting unit 111 acquires this search query and sends it to the subsequent search query conversion unit 112, the search query conversion unit 112 first segments the search query described in the W3C XPath language into search units called location steps. In FIG. 6C, the search query is segmented into two location steps “book” and “price”.

The search query conversion unit 112 operates as follows when it refers to the vocabulary list 141 exemplified in FIG. 3. More specifically, the search query conversion unit 112 acquires, from the vocabulary list 141 for the respective location steps, indices (EII) corresponding to character strings (book, price) which are node test values. Then, the search query conversion unit 112 generates information in the form of a table exemplified in FIG. 6D as a converted search query using the acquired indices for the respective location steps.

In FIG. 6D, the location step number of each location step is registered in a column 611. The axis of each location step is registered in a column 612. The node test value of each location step is registered in a column 613. The predicate of each location step is registered in a column 614.

In FIGS. 6A to 6D, only the element name of an element node is targeted as a character string to be converted. However, the Fast Infoset format allows managing even character strings such as an attribute name, namespace URI, and namespace prefix in the vocabulary list. The same conversion can be executed even when a location step in a search query has a description regarding an attribute node or namespace node other than an element node. The search query conversion unit 112 sends the converted search query to the search query conversion request accepting unit 111.

Referring back to FIG. 7, in step S706, the search query conversion request accepting unit 111 outputs the converted search query received from the search query conversion unit 112. Although the output destination is not particularly limited, the user inputs the search query into the apparatus for search. Thus, the search query can be held in the storage device 140 or memory 110 so that the user can handle it.

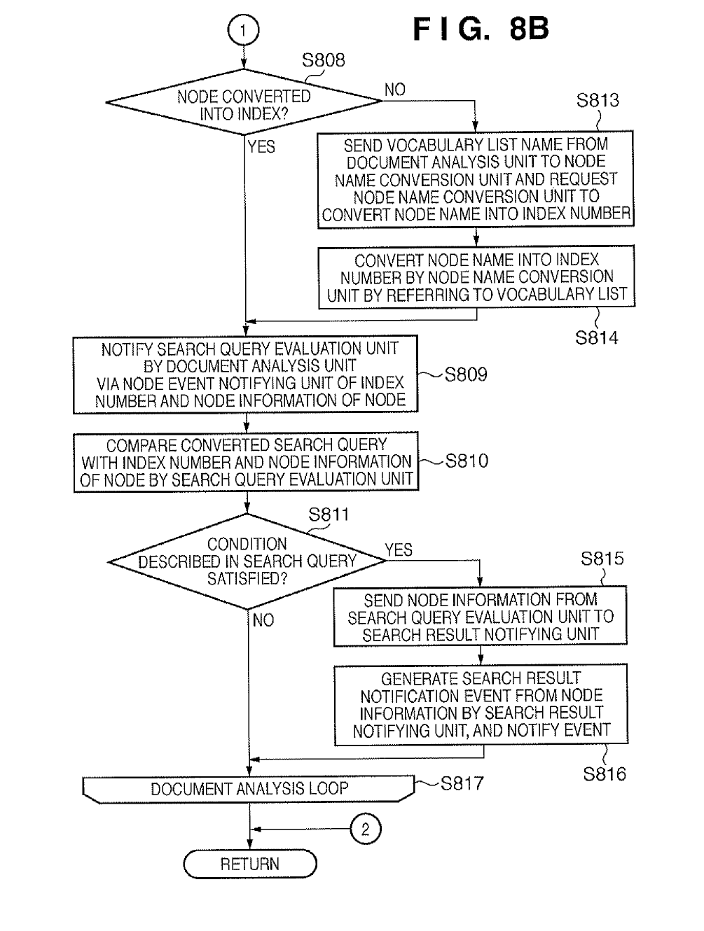

In step S707, processing to search for a target part of the structured document 142 using the converted search query is performed. FIGS. 8A and 8B are flowcharts each showing details of the processing in step S707.

First, the user of the apparatus inputs, with a keyboard and mouse (neither is shown) to the apparatus, a search query, the file name of a structured document to be searched using the search query, and the file name of a vocabulary list.

Then, in step S801, the search request accepting unit 118 acquires the input pieces of information. In the embodiment, the input search query is a search query converted in the processes of steps S701 to S706. The input file name of the structured document is assumed to be that of the structured document 142. The input file name of the vocabulary list is assumed to be that of the vocabulary list 141

In step S802, the search request accepting unit 118 sends the input search query to the search query evaluation unit 115. In step S803, the search request accepting unit 118 sends the input file names of the vocabulary list 141 and structured document 142 to the document analysis unit 119. Processes in steps S804 to S817 are performed for each building part of the structured document 142.

In step S805, the document analysis unit 119 sends, to the document read unit 120, the file name of the structured document 142 that has been received from the search request accepting unit 118. The document read unit 120 reads out the next part of the structured document 142 specified by the file name. When the processing in this step is executed for the first time, the document read unit 120 reads out the first part of the structured document 142. The “next part” means an unread part of the structured document that can be stored in a document read buffer area by the document read unit 120.

If there is no part to be read out in this step, the process ends via step S806. If the next part has been read out successfully, the process advances to step S807 via step S806.

In step S807, the document analysis unit 119 analyzes the part read out by the document read unit 120 and extracts the next node. In step S808, the document analysis unit 119 refers to the extracted node and determines whether the node has been converted into an index. When the node has been converted into an index, the index is described in an element start symbol (EII) in FIGS. 4 and 5 in the Fast Infoset format. Thus, it suffices to determine in step S808 whether an index is described in Eli.

If the document analysis unit 119 determines that the node has been converted into an index, the process advances to step S809; if NO, to step S813.

In step S813, the document analysis unit 119 sends, to the node name conversion unit 117, the file name of the vocabulary list 141 that has been received from the search request accepting unit 118 and the node name extracted in step S807.

In step S814, the node name conversion unit 117 specifies an index corresponding to the node name received from the document analysis unit 119 by referring to the vocabulary list 141 specified by the file name similarly received from the document analysis unit 119. The node name conversion unit 117 sends the specified index to the document analysis unit 119.

In step S809, the document analysis unit 119 sends node information of the node extracted in step S807 and the index of the node to the node event notifying unit 116. The node information includes the namespace definition of an element, the contents of character string data defined as element contents, a parent element, and an attribute value. The node event notifying unit 116 sends the information received from the document analysis unit 119 as an event to the search query evaluation unit 115.

In step S810, the search query evaluation unit 115 performs search processing by comparing the search query received from the search request accepting unit 118 in step S802 with the index received from the document analysis unit 119 via the node event notifying unit 116. For example, the search query evaluation unit 115 receives the search query shown in FIG. 6A in step S802, and receives indices “1”, “2”, and “3” in this order in step S809. In this case, the search query evaluation unit 115 determines that a node corresponding to this index is hit as a search target (satisfies a condition described in the search query).

If the search query evaluation unit 115 determines as a result of the comparison in step S810 that the condition described in the search query is satisfied, the process advances to step S815 via step S811. If the search query evaluation unit 115 determines that the condition described in the search query is not satisfied, the process advances to step S817 via step S811, and the subsequent processing is done for the next part.

In step S815, the search query evaluation unit 115 sends node information of the node hit in the search to the search result notifying unit 114. In step S816, the search result notifying unit 114 generates a search result notification event from the node information received from the search query evaluation unit 115, and outputs the generated search result notification event. The output destination is not particularly limited. For example, the search result notification event may be sent to an application program which displays the node information on the display device (not shown) of the document search apparatus 100.

When the search query is described in XPath, as shown in FIGS. 6A and 6C, the search result takes one data type among a node set, true/false (Boolean) value, numerical value, and character string. The form of the search result notification event complies with a preliminary agreement between the user of the apparatus and the search result notifying unit 114. For example, for a program described in the C language, the search query evaluation unit 115 invokes a function defined by the user of the apparatus and transfers it as the data type return value of the search result.

### Second Embodiment

In the first embodiment, the vocabulary list 141 is generated in advance and held in the storage device 140. However, according to the Fast Infoset format and the like, the structured document 142 can be analyzed while dynamically generating a vocabulary list without referring to a vocabulary list generated in advance from a schema definition or the like.

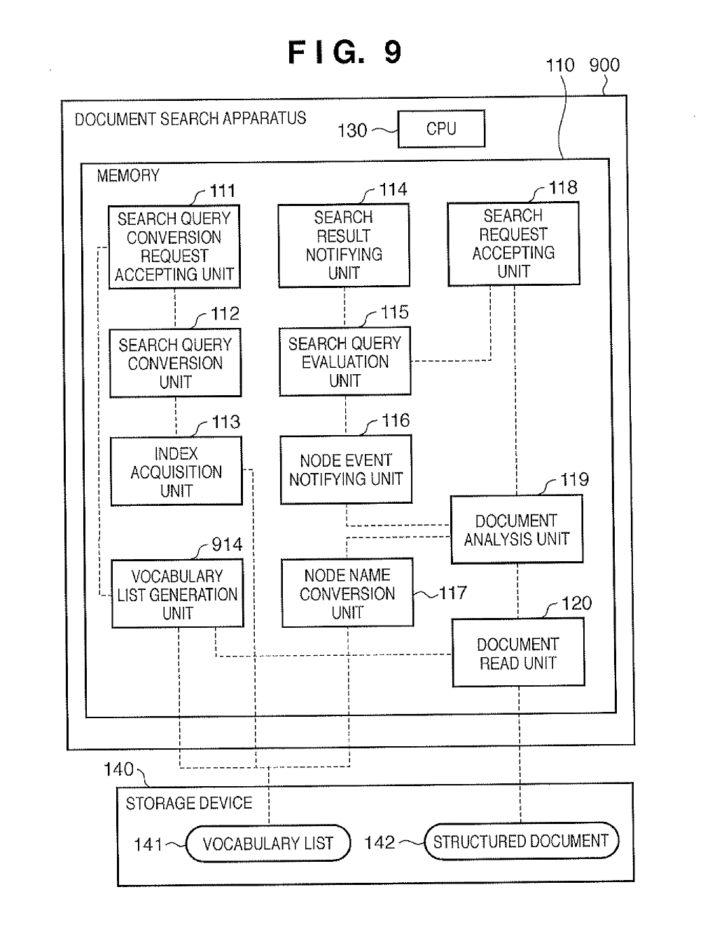

In the second embodiment, an arrangement for generating a vocabulary list 141 is added to the document search apparatus 100 according to the first embodiment. FIG. 9 is a block diagram exemplifying the hardware configuration of a document search apparatus 900 serving as an information processing apparatus according to the second embodiment. As shown in FIG. 9, the document search apparatus 900 includes a vocabulary list generation unit 914 for generating the vocabulary list 141, in addition to the arrangement shown in FIG. 1. In FIG. 9, the reference numerals as those in FIG. 1 denote the same parts, and a description thereof will not be repeated.

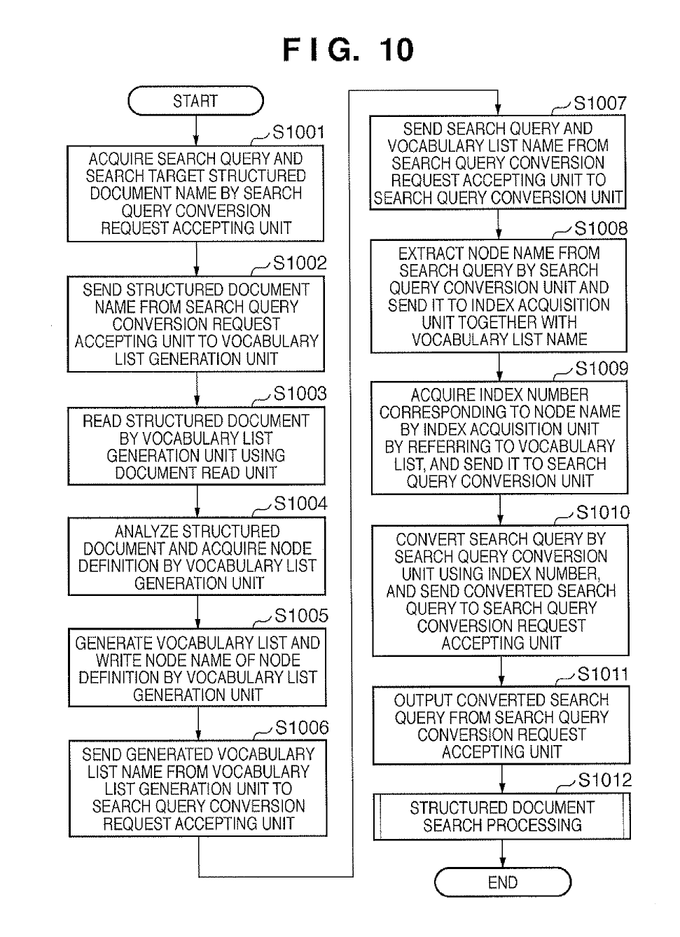

FIG. 10 is a flowchart of search processing for a structured document 142 by the document search apparatus 900. In step S1001, a search query conversion request accepting unit 111 acquires a search request by acquiring a search query and the file name of the structured document 142 from an application program or the like. The acquisition form of the search query and the file name of the structured document 142 is not particularly limited. In step S1002, the search query conversion request accepting unit 111 sends the acquired file name of the structured document 142 to the subsequent vocabulary list generation unit 914.

In step S1003, the vocabulary list generation unit 914 sends the file name received from the search query conversion request accepting unit 111 to a document read unit 120. The document read unit 120 reads out the structured document 142 specified by the file name. The document read unit 120 sends the readout structured document 142 to the vocabulary list generation unit 914.

In step S1004, the vocabulary list generation unit 914 analyzes the structured document 142, acquiring the node definitions of an element node, attribute node, namespace node, and the like. In step S1005, the vocabulary list 141 registers, in the vocabulary list 141, the node names of the element node and attribute node, and the namespace URI and namespace prefix of the namespace node.

In step S1006, the vocabulary list generation unit 914 issues the file name of the vocabulary list 141 generated in step S1005, and sends the issued file name to the search query conversion request accepting unit 111. Step S1007 and subsequent steps are the same as step S702 and subsequent steps in FIG. 7, and a description thereof will not be repeated.

According to the above-described embodiments, the number of character string comparison processes can be decreased when a specific part of a structured document compressed by a binary XML technique or the like is searched for using a search query. The specific part of the compressed structured document can therefore be searched for and extracted more quickly. This effect is significant especially when many node names such as an element name and attribute name are described in a search query and when the size of a search target document is large.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-097389, filed Apr. 13, 2009, which is hereby incorporated by reference herein in its entirety.

1. An information processing apparatus comprising:
a unit that holds a table in which each node usable in a structured document and an index unique to the node are registered;
a unit that acquires a search target structured document described in a binary format;
an acquisition unit that acquires a search query for the search target structured document;
a conversion unit that converts the search query by converting each node building the search query into a corresponding index by using the table;
a specifying unit that specifies an index corresponding to each node building the search target structured document by using the table;
a search unit that searches for part of the search target structured document that corresponds to the search query converted by said conversion unit, by using each index described in the search query converted by said conversion unit and the index corresponding to each node in the search target structured document that is specified by said specifying unit; and
a unit that outputs a result of the search by said search unit.

2. The apparatus according to claim 1, wherein the search target structured document is a structured document in a binary XML format defined by ISO Fast Infoset and W3C Efficient XML Interchange specifications.

3. The apparatus according to claim 1, wherein
the search query is described in a W3C XPath language, and
said conversion unit segments the search query acquired by said acquisition unit into location steps, acquires indices corresponding to the respective location steps from the table, and obtains, as the converted search query, a table in which a set of each location step and its corresponding index is registered.

4. The apparatus according to claim 1, further comprising generation unit that generates the table after acquiring the search target structured document.

5. An information processing method comprising:
a step of acquiring a search target structured document described in a binary format;
an acquisition step of acquiring a search query for the search target structured document;
a conversion step of converting the search query by converting each node building the search query into a corresponding index by using a table in which each node usable in a structured document and an index unique to the node are registered;
a specifying step of specifying an index corresponding to each node building the search target structured document by using the table;
a search step of searching for part of the search target structured document that corresponds to the search query converted in the conversion step, by using each index described in the search query converted in the conversion step and the index corresponding to each node in the search target structured document that is specified in the specifying step; and
a step of outputting a result of the search in the search step.

6. A non-transitory computer-readable storage medium storing a computer program for causing a computer to function as each units of an information processing apparatus defined in claim 1.
